(19) United States
(12) Patent Application Publication
(10) Pub. No.: US 2026/0203945 A1
(43) Pub. Date: Jul. 16, 2026

(54) Calibrations for a Vision Based System

(71) Applicant: Precision Planting LLC, Tremont, IL (US)

(72) Inventor: Michael Strnad, Delavan, IL (US)

(21) Appl. No.: 19/136,544

(22) PCT Filed: Nov. 27, 2023
(86) PCT No.: PCT/IB2023/061918

§ 371 Date: Jun. 6, 2025

Related U.S. Application Data
(60) Provisional application No. 63/386,201, filed on Dec. 6, 2022.

(51) Int. Cl. G06T 7/80; G06T 7/00; G06T 7/246; G06T 7/285; G06T 7/33; H04N 13/00; H04N 13/239

(52) U.S. Cl. CPC G06T 7/85; G06T 7/0014; G06T 7/248; G06T 7/285; G06T 7/337; H04N 13/239; G06T 2207/10021; G06T 2207/30004; G06T 2207/30188; G06T 2207/30244; H04N 2013/0081; H04N 2013/0085

(57) ABSTRACT

A computer implemented method for calibration of a camera comprises capturing, with the camera that is disposed on an implement, a sequence of images while the implement travels across a terrain, comparing a first image from an image sensor of the camera at a first time to a second image from the image sensor at a second time, determining matching points corresponding to features in common in the first image and in the second image, and determining at least one of height, pitch, roll, and yaw for the camera based on the first image, the second image, the matching points corresponding to features in common in the first image and in the second image, and a ground speed of the implement while capturing the first image at the first time and the second image at the second time.

### CROSS REFERENCE TO RELATED APPLICATIONS

This application claims priority to U.S. Application No. 63/386,201, filed on 6 Dec. 2022, which is incorporated herein by reference in its entirety.

### FIELD

Embodiments of the present disclosure relate generally to calibrations for a vision based system.

### BACKGROUND

Sprayers and other fluid application systems are used to apply fluids (such as fertilizer, herbicide, insecticide, and/or fungicide) to fields. Cameras located on the sprayers can capture images of the spray pattern, weeds, and plants growing in an agricultural field. A lens installation with the camera has manufacturing variability and this leads to error in determining locations of plants and weeds in the field. A camera having even a slight change in orientation while mounted on an implement will also lead to error in image based calculations.

### BRIEF DESCRIPTION OF THE DRAWINGS

FIG. 1 is an illustration of an agricultural crop sprayer.

FIG. 2 is a rear elevation view of a spray boom with cameras according to one embodiment.

FIG. 3 illustrates an exemplary camera 70 with multiple lenses in accordance with one embodiment.

FIG. 4 illustrates a flow diagram of one embodiment for a computer-implemented method of using images captured by a camera having multiple image sensors and lenses to calibrate the camera when the camera is positioned on an implement.

FIG. 5 illustrates images that have been sequentially captured for a camera calibration process in accordance with one embodiment.

FIG. 6 illustrates determining matching points or features in the images that have been sequentially captured for a camera calibration process in accordance with one embodiment.

FIG. 7 illustrates determining a large number of matching points or features in the images that have been sequentially captured for a camera calibration process in accordance with one embodiment.

FIG. 8 illustrates determining a forward distance traveled by the implement between capturing the image 510 at a time T₀=0 seconds and capturing the image 520 at a time T₁=0.1 seconds.

FIG. 9 illustrates a ground plane projection 900 for a camera 920 in accordance with one embodiment.

FIG. 10 illustrates a flow diagram of one embodiment for a computer-implemented method of using images captured by a camera having multiple image sensors and lenses to perform a stereo calibration between first and second image sensors of the camera when the camera is positioned on an implement.

FIG. 11A shows an example of a block diagram of a self-propelled implement 140 (e.g., sprayer, spreader, irrigation implement, etc.) in accordance with one embodiment.

FIG. 11B shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment.

### BRIEF SUMMARY

In an aspect of the disclosure there is provided a method of calibration of a camera comprising capturing, with the camera that is disposed on an implement, a sequence of images while the implement travels across a terrain, comparing a first image from an image sensor of the camera at a first time to a second image from the image sensor at a second time, determining matching points corresponding to features in common in the first image and in the second image, and determining at least one of height, pitch, roll, and yaw for the camera based on the first image, the second image, the matching points corresponding to features in common in the first image and in the second image, and a ground speed of the implement while capturing the first image at the first time and the second image at the second time.

In one example of this method, the method further comprises receiving x and y (e.g., lateral and longitudinal) positions of the camera with respect to a centerline of the implement.

In one example of this method, the method further comprises receiving a steering angle from a steering sensor of the implement and receiving the ground speed of the implement while capturing the first image at the first time and the second image at the second time from a speed sensor.

In one example of this method, the method further comprises determining a forward distance traveled by the implement between capturing the first image at the first time and second image at the second time.

In one example of this method, the height, pitch, roll, and yaw for the camera are determined based on the first image and the second image.

In one example of this method, the features in common in the first image and in the second image include a region of a plant or a weed in the agricultural field.

In one example of this method, the camera is disposed to look ahead in a direction of travel of the implement or to look downwards.

In an aspect of the disclosure there is provided a system comprising an agricultural implement, a camera disposed on the agricultural implement, the camera is configured to capture a sequence of images while the agricultural implement travels through an agricultural field, and a processor that is configured to compare a first image from an image sensor of the camera at a first time to a second image from the image sensor at a second time, determine matching points corresponding to features in common in the first image and in the second image, and determine at least one of height, pitch, roll, and yaw for the camera based on the first image, the second image, the matching points corresponding to features in common in the first image and in the second image, and a ground speed of the agricultural implement while capturing the first image at the first time and the second image at the second time.

In one example of the system, the processor is further configured to receive x and y (e.g., lateral and longitudinal) positions of the camera with respect to a centerline of the agricultural implement.

In one example of the system, the processor is further configured to receive a steering angle from a steering sensor of the implement and to receive the ground speed of the implement while capturing the first image at the first time and the second image at the second time from a speed sensor.

In one example of the system, the processor is further configured to determine a forward distance traveled by the implement between capturing the first image at the first time and second image at the second time.

In one example of the system, the features in common in the first image and in the second image include a region of a plant or a weed in the agricultural field.

In one example of the system, the height, pitch, roll, and yaw for the camera are determined based on the first image and the second image, and known machine translation between those frames of the first and second images.

In one example of the system, the camera is disposed to look ahead in a direction of travel of the implement or to look downwards.

In an aspect of the disclosure there is provided a computer implemented method for aligning a second image sensor with a first image sensor of a camera, comprising using a calculated height, pitch, roll, and yaw for the camera that is disposed on an implement to calculate a real world projection matrix for the first image sensor to allow features, image points, or pixels from an image space to be projected into a real world ground projected coordinates, determining a value for each corner point for the real world ground projected coordinates from the first image sensor, calculating a nominal disparity based on each of the corner points for the real world ground projected coordinates and corner points in image space of the first image sensor, warping a first image from the first image sensor by the nominal disparity for each of those corner points, and determining a registration matrix to align a second raw image from the second image sensor with the disparity warped first image based on intrinsic camera parameters.

In one example of this method, the intrinsic camera parameters include a focal length and a pixel spacing of a first lens of the first image sensor.

In one example of this method, the method further comprises determining a height of the camera for each frame based on a determined distance from the camera to a feature including a plant or weed in an agricultural field.

In one example of this method, the height, pitch, roll, and yaw for the camera are determined from a camera calibration process.

In one example of this method, the camera comprises a stereo vision camera.

### DETAILED DESCRIPTION

All references cited herein are incorporated herein in their entireties. If there is a conflict between a definition herein and in an incorporated reference, the definition herein shall control.

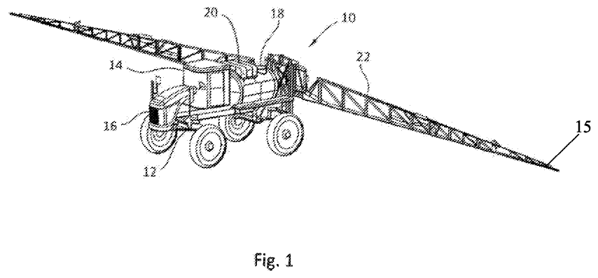

Referring to the drawings, wherein like reference numerals designate identical or corresponding parts throughout the several views, FIG. 1 illustrates an agricultural implement, such as a sprayer 10. While the system 15 can be used on a sprayer, the system can be used on any agricultural implement that is used to apply fluid to soil, such as a side-dress bar, a planter, a seeder, an irrigator, a center pivot irrigator, a tillage implement, a tractor, a cart, or a robot. A reference to boom or boom arm herein includes corresponding structures, such as a toolbar, in other agricultural implements.

FIG. 1 shows an agricultural crop sprayer 10 used to deliver chemicals to agricultural crops in a field. Agricultural sprayer 10 comprises a chassis 12 and a cab 14 mounted on the chassis 12. Cab 14 may house an operator and a number of controls for the agricultural sprayer 10. An engine 16 may be mounted on a forward portion of chassis 12 in front of cab 14 or may be mounted on a rearward portion of the chassis 12 behind the cab 14. The engine 16 may comprise, for example, a diesel engine or a gasoline powered internal combustion engine. The engine 16 provides energy to propel the agricultural sprayer 10 and also can be used to provide energy used to spray fluids from the sprayer 10.

Although a self-propelled application machine is shown and described hereinafter, it should be understood that the embodied invention is applicable to other agricultural sprayers including pull-type or towed sprayers and mounted sprayers, e.g. mounted on a 3-point linkage of an agricultural tractor.

The sprayer 10 further comprises a liquid storage tank 18 used to store a spray liquid to be sprayed on the field. The spray liquid can include chemicals, such as but not limited to, herbicides, pesticides, and/or fertilizers. Liquid storage tank 18 is to be mounted on chassis 12, either in front of or behind cab 14. The crop sprayer 10 can include more than one storage tank 18 to store different chemicals to be sprayed on the field. The stored chemicals may be dispersed by the sprayer 10 one at a time or different chemicals may be mixed and dispersed together in a variety of mixtures. The sprayer 10 further comprises a rinse water tank 20 used to store clean water, which can be used for storing a volume of clean water for use to rinse the plumbing and main tank 18 after a spraying operation.

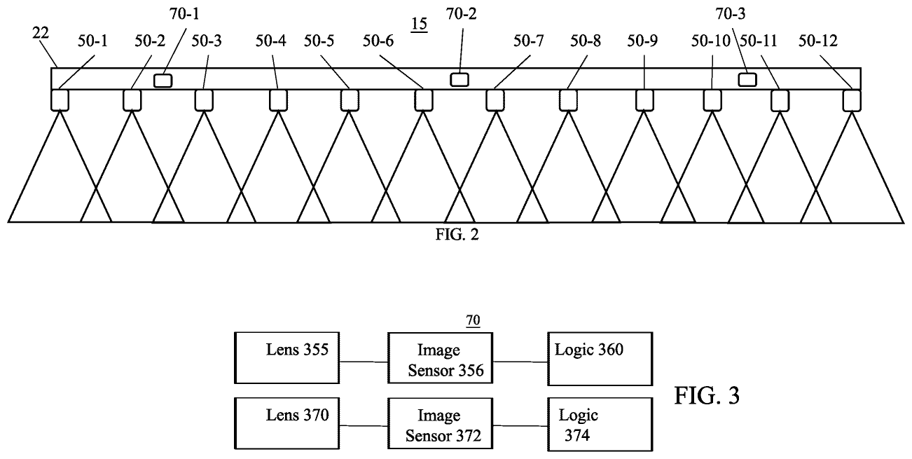

At least one boom arm 22 on the sprayer 10 is used to distribute the fluid from the liquid tank 18 over a wide swath as the sprayer 10 is driven through the field. The boom arm 22 is provided as part of a spray applicator system 15 as illustrated in FIGS. 1 and 2, which further comprises an array of spray nozzles (in addition to cameras, and processors described later) arranged along the length of the boom arm 22 and suitable sprayer plumbing used to connect the liquid storage tank 18 with the spray nozzles. The sprayer plumbing will be understood to comprise any suitable tubing or piping arranged for fluid communication on the sprayer 10. Boom arm 22 can be in sections to permit folding of the boom arm for transport.

Additional components that can be included, such as control modules or lights, are disclosed in PCT Publication No. WO2020/178663 and U.S. Application No. 63/050,314, filed 10 Jul. 2020, respectively.

Illustrated in FIG. 2, there are a plurality of nozzles 50 (50-1 to 50-12) disposed on boom arm 22. While illustrated with 12 nozzles 50, there can be any number of nozzles 50 disposed on boom arm 22. Nozzles 50 dispense material (such as fertilizer, herbicide, or pesticide) in a spray. In any of the embodiments, nozzles 50 can be actuated with a pulse width modulation (PWM) actuator to turn the nozzles 50 on and off. In one example, the PWM actuator drives to a specified position (e.g., full open position, full closed position) according to a pulse duration, which is a length of the signal.

Illustrated in FIG. 23, there are a plurality of cameras 70 (e.g., 70-1, 70-2, 70-3) each disposed on the boom arm 22 with each viewing an area of the ground generally forward of the boom in the direction of normal implement travel.

A combined camera 70 includes a light unit. A reference to camera 70 is to either a camera or camera/light unit unless otherwise specifically stated.

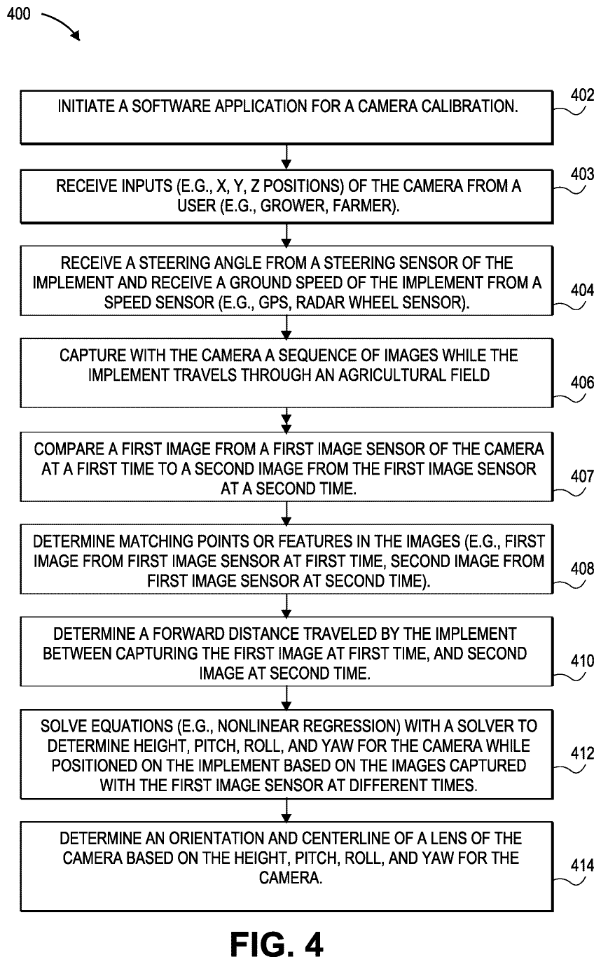

Cameras 70 can be installed at various locations across a field operation width of an implement or boom arm 22. Cameras 70 can have a plurality of lenses. An exemplary camera 70 is illustrated in FIG. 3 with lenses 355 and 370. Each lens can have a different field of view. The different fields of view can be obtained by different focal lengths of the lens. Cameras 70 can be positioned to view spray from nozzles 50 for flow, blockage, or drift, to view for guidance, for obstacle avoidance, to identify plants, to identify weeds, to identify insects, to identify diseases, or combinations thereof.

While illustrated rearward of boom arm 22 along the direction of travel of sprayer 10, cameras 70 can be disposed forward of boom arm 22 along a direction of travel of sprayer 10. This can be beneficial when boom arm 22 is mounted to the front of sprayer 10 instead of the back, and boom arm 22 pivots rearwardly for transport.

Cameras 70 can be connected to a display device or a monitor system 1000, such as the monitor system disclosed in U.S. Pat. No. 8,078,367. Camera 70, display device, processing system, or monitor system 1000 can each process the images captured by camera 70 or share the processing of the images. In one embodiment, the images captured by camera 70 can be processed in camera 70 and the processed images can be sent to monitor system. In another embodiment, the images can be sent to monitor system for processing. Processed images can be used to identify flow, to identify blockage, to identify drift, to view for guidance, for obstacle avoidance, to identify plants, to identify weeds, to identify insects, to identify diseases, or combinations thereof. Once identified, monitor system can alert an operator of the condition and/or send a signal to a device to address the identified condition, such as to a nozzle 50 to activate to apply herbicide to a weed.

Camera 70 can be any type of camera. Examples of cameras include, but are not limited to, digital camera, line scan camera, monochrome, RGB (red, green blue), NIR (near infrared), SWIR (short wave infrared), MWIR (medium wave infrared), LWIR (long wave infrared), optical sensor (including receiver or transmitter/receiver), reflectance sensor, laser.

In some embodiments, a camera 70 (e.g., stereo vision camera 70) includes an image sensor 356 for lens 355 and an image sensor 372 for lens 370 of FIG. 3. In one example, the sensor 356 is a RGB image sensor with an IR blocking filter. The sensor 356 may have millions of photosites that each represent a pixel of a captured image. Photosites catch the light, but cannot distinguish between the different wavelengths-therefore cannot capture the color. To get a color image, a thin color filter array is placed over the photodiodes. This filter includes RGB blocks of which each is placed on top of the photodiode. Now, each of the RGB blocks can capture the intensity of the RGB. Processing logic (e.g., a processor, a graphics processor, a graphics processing unit (GPU)) of the logic 360 analyzes the color and intensity of each photosite and the processed data is temporarily buffered or stored in memory of the camera until being sent to an arbiter or other component for processing.

The image sensor 372 has a filter that allows IR light to pass to the image sensor 372. The first and second image sensors have a slight offset from each other. A processor of the logic 374 analyzes the intensity of each photosite and the processed data is temporarily buffered or stored in memory of the camera until being sent to the arbiter other component for processing. In another embodiment, the image sensors 356 and 372 share the same digital logic.

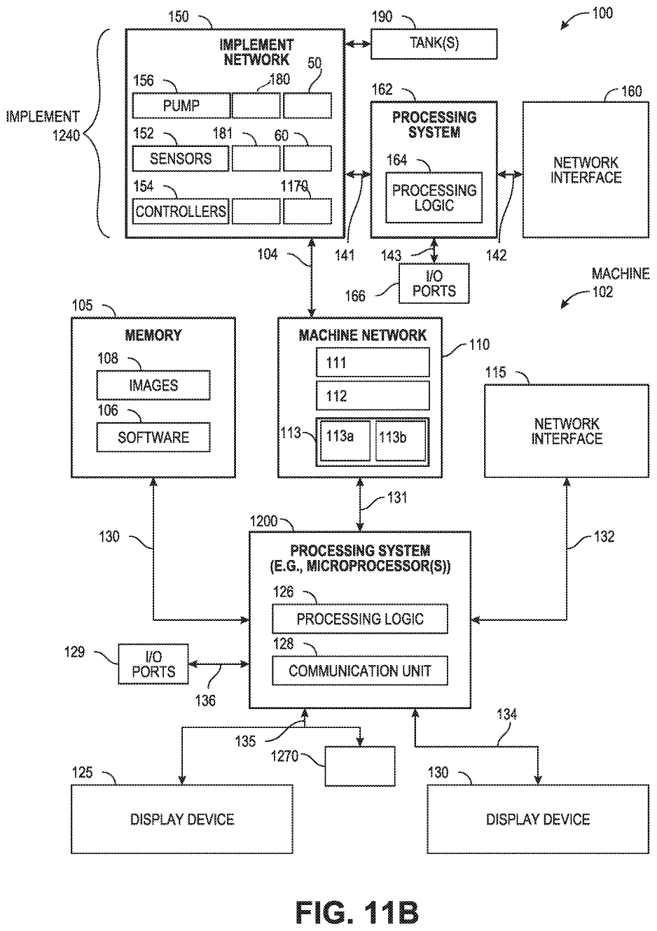

In one embodiment, nozzles 50 and cameras 70 are connected to a network. An example of a network is described in PCT Publication No. WO2020/039295A1 and is illustrated as implement network 150 in FIG. 11A and FIG. 11B.

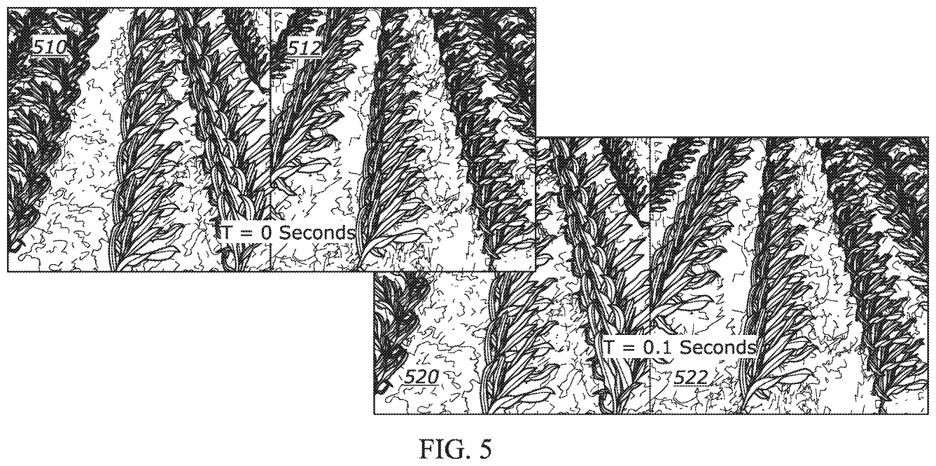

FIG. 4 illustrates a flow diagram of one embodiment for a computer-implemented method of using images captured by a camera having multiple image sensors (e.g., left and right image sensors) and lenses to calibrate the camera when the camera is positioned on an implement. An optical centerline of a lens of the camera can be calibrated with the captured images. An optical centerline can be defined as the central point of the lens through which a ray of light passes without suffering any deviation. The method 400 is performed by processing logic that may comprise hardware (circuitry, dedicated logic, a processor, a graphics processor, a GPU, etc.), software (such as is run on a general purpose computer system or a dedicated machine or a device), or a combination of both. In one embodiment, the method 400 is performed by processing logic of a processing system (e.g., processing system 162, 1200), a camera, or a monitor (e.g., monitor system). The camera can be attached to a boom or any implement as described herein.

At operation 402, the computer-implemented method initiates a software application for agricultural field operations and camera calibration. A user can select a calibration option from the software application to initiate the camera calibration. At operation 403, the software application receives one or more inputs (e.g., x, y, z positions) of the camera from a user (e.g., grower, farmer) or the software application may have previously received positional information for the camera. The inputs (e.g., x, y, z positions) of the camera can be measured with respect to a centerline of an implement and with respect to a ground level. The camera is disposed on an implement. At operation 404, the software application receives a steering angle from a steering sensor of the implement and receives a ground speed of the implement from a speed sensor (e.g., GPS, RADAR wheel sensor). At operation 406, the camera captures a sequence of images while the implement travels across a terrain (e.g., across an agricultural field, a parking lot, a road, a generally flat space, etc.). The steering angle will indicate whether the implement is traveling in a straight line or with curvature.

At operation 407, the computer-implemented method compares a first image from a first image sensor (e.g., right image sensor, alternatively left image sensor, upper or lower image sensor) of the camera at a first time to a second image from the first image sensor at a second time.

At operation 408, computer-implemented method determines matching points or features in the images (e.g., first image from first image sensor at first time, second image from first image sensor at second time) that have been sequentially captured for a camera calibration process in accordance with one embodiment.

At operation 410, the computer-implemented method determines a forward distance traveled by the implement between capturing the first image from first image sensor at first time, and second image from first image sensor at second time.

At operation 412, the computer-implemented method solves equations (e.g., nonlinear regression) with processing logic (e.g., processing logic that is executing a solver) to determine height, pitch, roll, and yaw for the camera while positioned on the implement based on the images captured with the first image sensor at different times. At operation 414, the computer-implemented method determines an orientation and centerline of a lens of the first image sensor of the camera based on the height, pitch, roll, and yaw for the camera. The orientation of the lens can be determined precisely within a few tenths of a degree and this is important due to the camera viewing plants and weeds that are approximately 15 to 20 feet in front of the camera. The precise determination of the orientation of the lens improves any image based calculations and identifications for plants and weeds in the agricultural field.

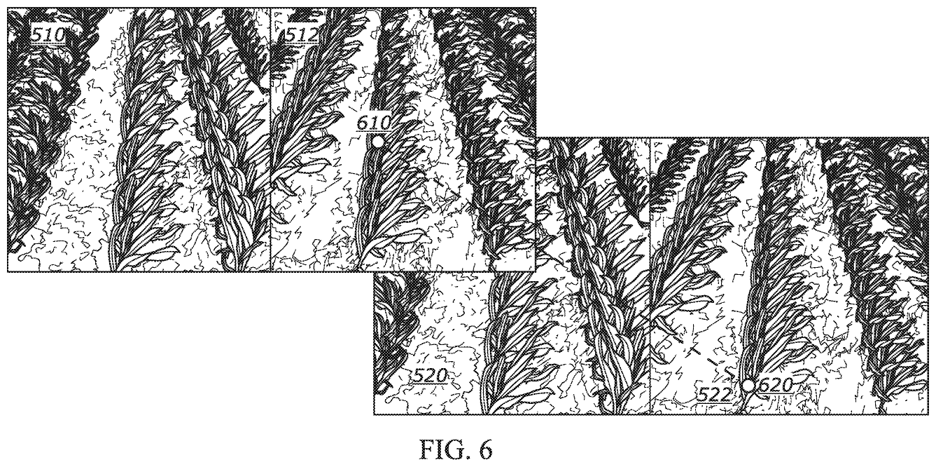

FIGS. 5-9 provide illustrations for how captured images from the first image sensor are used for the camera calibration process to determine height, pitch, roll, and yaw for the camera. FIG. 5 illustrates images that have been sequentially captured for a camera calibration process in accordance with one embodiment. The camera is disposed on an implement that is traveled at a known speed through rows of plants in an agricultural field. The camera includes a left image sensor to capture the image 510 at a time T₀=0 seconds and to capture the image 520 at a time T₁=0.1 seconds. A right image sensor captures the image 512 at a time T₀=0 seconds and captures the image 522 at a time T₁=0.1 seconds. In one example, the right image sensor is the first image sensor from method 400.

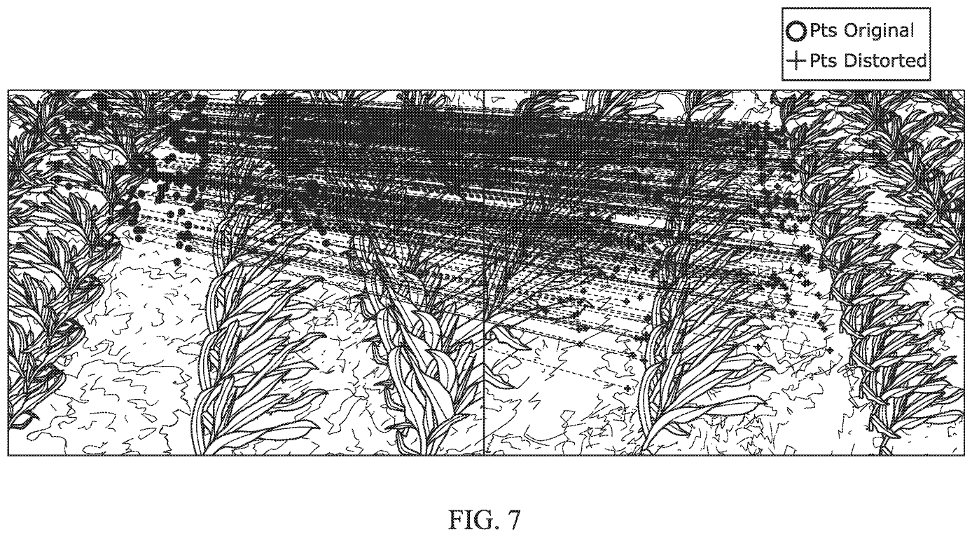

FIG. 6 illustrates determining matching points or features in the images that have been sequentially captured for a camera calibration process in accordance with one embodiment. The point 610 in image 512 matches the point 620 in image 522. Points 610 and 620 correspond to the same feature of a plant.

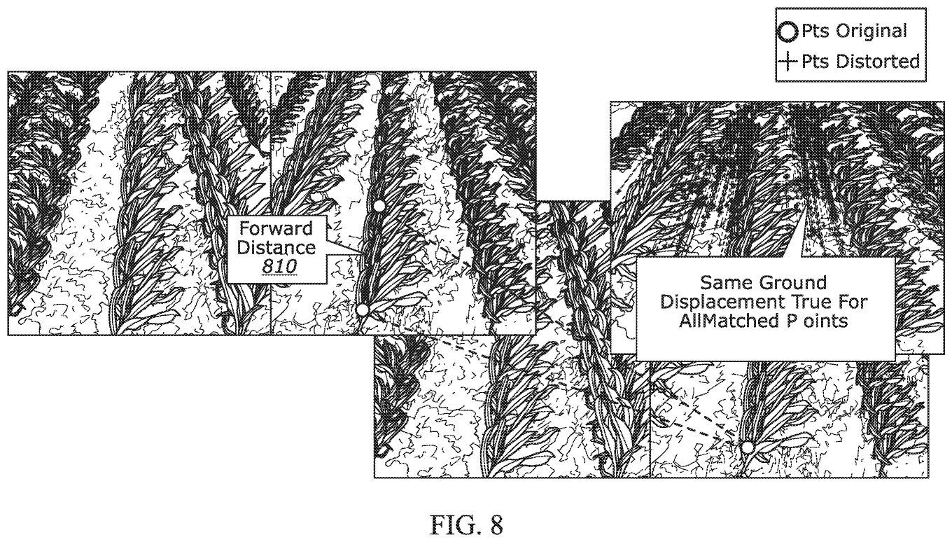

FIG. 7 illustrates determining a large number of matching points or features in the images that have been sequentially captured for a camera calibration process in accordance with one embodiment. The point 710 in image 512 matches the point 720 in image 522.

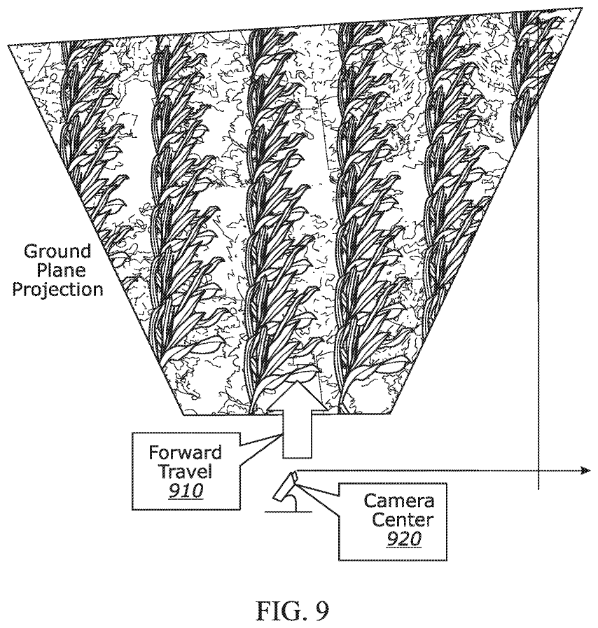

FIG. 8 illustrates determining a forward distance traveled by the implement between capturing the image 510 at a time T₀=0 seconds and capturing the image 520 at a time T₁=0.1 seconds. Given that distance=speed*time, the forward distance 810 can be calculated based on the known ground speed of the implement multiplied by delta time between T₀ and T₁.

The following equations are then formed; and solved with a solver:

$$Ground\_position = function ( imR\_x , imR\_y , height , pitch , roll , yaw , + some other fixed camera intriniscs ( e . g . , focal length of right lens ) .$$

$$Ground\_postion1 = Ground\_position2 - ( speed \times frame dT ) .$$

$$imR1\_x / y \& imR2\_x / y are paired list of points .$$

$$function ( imR1\_x , imR1\_y , height , pitch , roll , yaw ) = function ( imR2\_x , imR2\_y , height , pitch , roll , yaw ) - ( speed \times frame dT ) .$$

ImR_x and imR_y are x and y coordinates for images captured with a right lens. These equations are solved (e.g., nonlinear regression) with a solver to determine height, pitch, roll, and yaw for the camera while positioned on the implement based on the images captured with an image sensor (e.g., right image sensor) at different times.

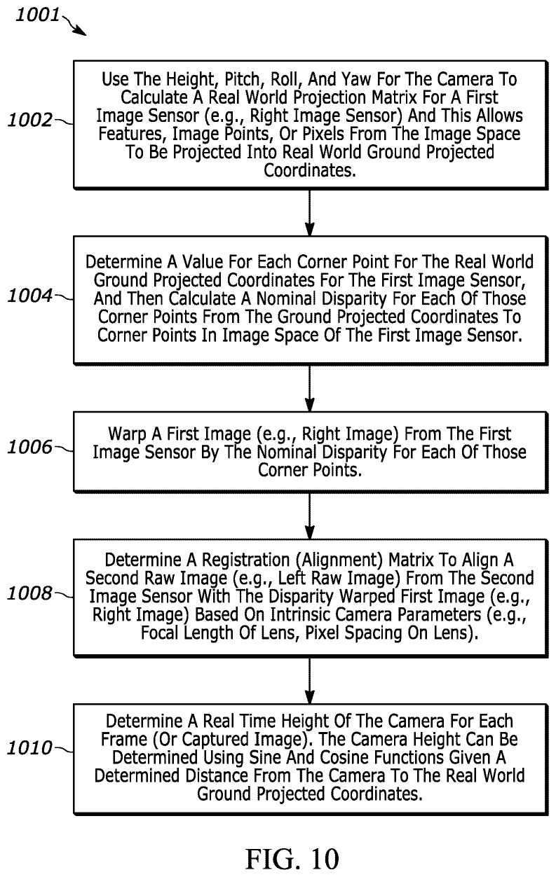

The height, pitch, roll, and yaw for the camera are then used to calculate a projection matrix and this allows features or pixels from the image space to be projected into real world coordinates. FIG. 9 illustrates a ground plane projection 900 for a camera 920 in accordance with one embodiment. The features or pixels from the image space are projected into the ground plane projection 900. The upward arrow indicates a direction 910 of forward travel of the implement.

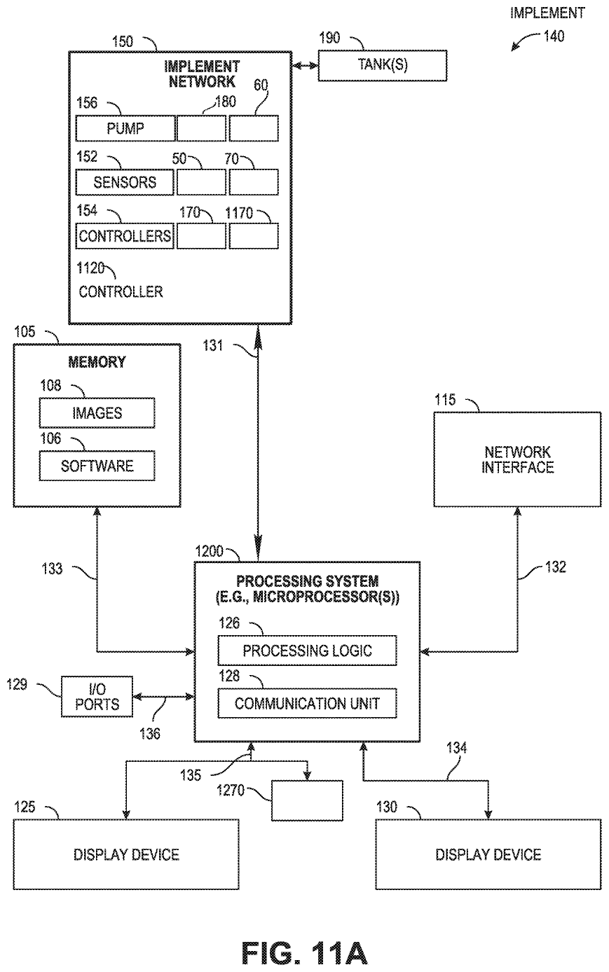

FIG. 10 illustrates a flow diagram of one embodiment for a computer-implemented method of using images captured by a camera having multiple image sensors and lenses to perform an essential stereo calibration between first and second image sensors of the camera when the camera is positioned on an implement. The method 1001 is performed by processing logic that may comprise hardware (circuitry, dedicated logic, a processor, a graphics processor, a GPU, etc.), software (such as is run on a general purpose computer system or a dedicated machine or a device), or a combination of both. In one embodiment, the method 1001 is performed by processing logic of a processing system (e.g., processing system 162, 1200), a camera, or a monitor (e.g., monitor system). The camera can be attached to a boom or any implement as described herein.

At operation 1002, the computer-implemented method uses the height, pitch, roll, and yaw for the camera to calculate a real world projection matrix for a first image sensor (e.g., right image sensor) for any image point and this allows features, image points, or pixels from the image space to be projected into real world ground projected coordinates. The height, pitch, roll, and yaw for the camera are determined from method 400 and after this calibration of the first image sensor the ground projected coordinates are assumed to be ground truth.

At operation 1004, the computer-implemented method determines a value for each corner point for the real world ground projected coordinates from the first image sensor, and can then calculate a nominal disparity (e.g., 2.1 pixel disparity for a first corner point, 2.0 pixel disparity for a second corner point, 14 pixel disparity for a third corner point, 15 pixel disparity for a fourth corner point) for each of those corner points from the ground projected coordinates to corner points in image space of the first image sensor.

At operation 1006, the computer-implemented method warps a first image (e.g., right image) from the first image sensor by the nominal disparity for each of those corner points.

At operation 1008, the computer-implemented method determines a registration (alignment) matrix to align a second raw image (e.g., left raw image) from the second image sensor with the disparity warped first image (e.g., right image) based on intrinsic camera parameters (e.g., focal length of lens, pixel spacing on lens). The resultant registration (i.e., essential or homography) matrix is the stereo calibration matrix for images (e.g., left images) from the second image sensor. This essential matrix is true for using “zero distortion” lenses, additional steps would be required for lenses with barrel distortion. The method 1001 assumes a relatively flat or planar ground surface (e.g., parking lot, open field with no large plants). The method 1001 can be performed initially for recently installed cameras on an implement or when camera orientation or position is changed. At operation 1010, the computer-implemented method determines a real time height of the camera for each frame (or captured image). The camera height can be determined using sine and cosine functions given a determined distance from the camera to the real world ground projected coordinates.

Although the operations in the computer-implemented methods disclosed herein are shown in a particular order, the order of the actions can be modified. Thus, the illustrated embodiments can be performed in a different order, and some operations may be performed in parallel. Some of the operations listed in the methods disclosed herein are optional in accordance with certain embodiments. The numbering of the operations presented is for the sake of clarity and is not intended to prescribe an order of operations in which the various operations must occur. Additionally, operations from the various flows may be utilized in a variety of combinations.

FIG. 11A shows an example of a block diagram of a self-propelled implement 140 (e.g., sprayer, spreader, irrigation implement, etc.) in accordance with one embodiment. The implement 140 includes a processing system 1200, memory 105, and a network interface 115 for communicating with other systems or devices. The network interface 115 can include at least one of a GPS transceiver, a WLAN transceiver (e.g., WiFi), an infrared transceiver, a Bluetooth transceiver, Ethernet, or other interfaces from communications with other devices and systems. The network interface 115 may be integrated with the implement network 150 or separate from the implement network 150 as illustrated in FIG. 11A. The I/O ports 129 (e.g., diagnostic/on board diagnostic (OBD) port) enable communication with another data processing system or device (e.g., display devices, sensors, etc.).

In one example, the self-propelled implement 140 performs operations for fluid applications of a field. Data associated with the fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the network interface 115 or implement network 150. The communication unit 128 may be integrated with the processing system or separate from the processing system.

Processing logic 126 including one or more processors may process the communications received from the communication unit 128 including agricultural data (e.g., planting data, GPS data, fluid application data, flow rates, etc.). The system 1200 includes memory 105 for storing data and programs for execution (software 106) by the processing system. The memory 105 can store, for example, software components such as fluid application software for analysis of fluid applications for performing operations of the present disclosure, or any other software application or module, images (e.g., captured images of crops, images of a spray pattern for rows of crops, images for camera calibrations), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 1200 communicates bi-directionally with memory 105, implement network 150, network interface 115, display device 130, display device 125, and I/O ports 129 via communication links 131-136, respectively.

Display devices 125 and 130 can provide visual user interfaces for a user or operator. The display devices may include display controllers. In one embodiment, the display device 125 is a portable tablet device or computing device with a touchscreen that displays data (e.g., planting application data, liquid or fluid application data, captured images, localized view map layer, high definition field maps of as-applied liquid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied liquid or fluid application data, as-planted or as-harvested data, yield data, controlling an implement (e.g., planter, tractor, combine, sprayer, etc.), steering the implement, and monitoring the implement (e.g., planter, combine, sprayer, etc.). A cab control module 1270 may include an additional control module for enabling or disabling certain components or devices of the implement.

The implement 140 (e.g., planter, cultivator, plough, sprayer, spreader, irrigation, implement, etc.) includes an implement network 150 having multiple networks. The implement network 150 having multiple networks (e.g., Ethernet network, Power over Ethernet (POE) network, a controller area network (CAN) serial bus protocol network, an ISOBUS network, etc.) may include a pump 156 for pumping liquid or fluid from a storage tank(s) 190 to row units of the implement, communication module 180 for receiving communications from controllers and sensors and transmitting these communications. In one example, the implement network 150 includes nozzles 50, lights 60, and vision guidance system 70 having cameras and processors for various embodiments of this present disclosure.

Sensors 152 (e.g., speed sensors, seed sensors for detecting passage of seed, downforce sensors, actuator valves, OEM sensors, flow sensors, etc.), controllers 154 (e.g., drive system, GPS receiver), and the processing system 120 control and monitoring operations of the implement.

The OEM sensors may be moisture sensors or flow sensors, speed sensors for the implement, fluid application sensors for a sprayer, or vacuum, lift, lower sensors for an implement. For example, the controllers may include processors in communication with a plurality of sensors. The processors are configured to process data (e.g., fluid application data) and transmit processed data to the processing system 120. The controllers and sensors may be used for monitoring motors and drives on the implement.

FIG. 11B shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment. The machine 102 includes a processing system 1200, memory 105, machine network 110 that includes multiple networks (e.g., an Ethernet network, a network with a switched power line coupled with a communications channel (e.g., Power over Ethernet (POE) network), a controller area network (CAN) serial bus protocol network, an ISOBUS network, etc.), and a network interface 115 for communicating with other systems or devices including the implement 1240. The machine network 110 includes sensors 112 (e.g., speed sensors), controllers 111 (e.g., GPS receiver, radar unit) for controlling and monitoring operations of the machine or implement. The network interface 115 can include at least one of a GPS transceiver, a WLAN transceiver (e.g., WiFi), an infrared transceiver, a Bluetooth transceiver, Ethernet, or other interfaces from communications with other devices and systems including the implement 1240. The network interface 115 may be integrated with the machine network 110 or separate from the machine network 110 as illustrated in FIG. 11B. The I/O ports 129 (e.g., diagnostic/on board diagnostic (OBD) port) enable communication with another data processing system or device (e.g., display devices, sensors, etc.).

In one example, the machine is a self-propelled machine that performs operations of a tractor that is coupled to and tows an implement for planting or fluid applications of a field. Data associated with the planting or fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the machine via machine network 110 or network interface 115 or implement via implement network 150 or network interface 160. The communication unit 128 may be integrated with the processing system or separate from the processing system. In one embodiment, the communication unit 128 is in data communication with the machine network 110 and implement network 150 via a diagnostic/OBD port of the I/O ports 129 or via network devices 113a and 113b. A communication module 113 includes network devices 113a and 113b. The communication module 113 may be integrated with the communication unit 128 or a separate component.

Processing logic 126 including one or more processors may process the communications received from the communication unit 128 including agricultural data (e.g., planting data, GPS data, liquid application data, flow rates, calibration data for camera calibrations, etc.). The system 1200 includes memory 105 for storing data and programs for execution (software 106) by the processing system. The memory 105 can store, for example, software components such as planting application software for analysis of planting applications for performing operations of the present disclosure, or any other software application or module, images (e.g., images for camera calibrations, captured images of crops), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 120 communicates bi-directionally with memory 105, machine network 110, network interface 115, display device 130, display device 125, and I/O ports 129 via communication links 130-136, respectively.

Display devices 125 and 130 can provide visual user interfaces for a user or operator. The display devices may include display controllers. In one embodiment, the display device 125 is a portable tablet device or computing device with a touchscreen that displays data (e.g., planting application data, liquid or fluid application data, captured images, localized view map layer, high definition field maps of as-applied liquid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied liquid or fluid application data, as-planted or as-harvested data, yield data, controlling a machine (e.g., planter, tractor, combine, sprayer, etc.), steering the machine, and monitoring the machine or an implement (e.g., planter, combine, sprayer, etc.) that is connected to the machine with sensors and controllers located on the machine or implement.

A cab control module 1270 may include an additional control module for enabling or disabling certain components or devices of the machine or implement. For example, if the user or operator is not able to control the machine or implement using one or more of the display devices, then the cab control module may include switches to shut down or turn off components or devices of the machine or implement.

The implement 1240 (e.g., planter, cultivator, plough, sprayer, spreader, irrigation, implement, etc.) includes an implement network 150 having multiple networks, a processing system 162 having processing logic 164, a network interface 160, and optional input/output ports 166 for communicating with other systems or devices including the machine 102. The implement network 150 having multiple networks (e.g, Ethernet network, Power over Ethernet (POE) network, a controller area network (CAN) serial bus protocol network, an ISOBUS network, etc.) may include a pump 156 for pumping liquid or fluid from a storage tank(s) 190 to row units of the implement, communication modules (e.g., 180, 181) for receiving communications from controllers and sensors and transmitting these communications to the machine network. In one example, the communication modules include first and second network devices with network ports. A first network device with a port (e.g., CAN port) of communication module (CM) 180 receives a communication with data from controllers and sensors, this communication is translated or converted from a first protocol into a second protocol for a second network device (e.g., network device with a switched power line coupled with a communications channel, Ethernet), and the second protocol with data is transmitted from a second network port (e.g., Ethernet port) of CM 180 to a second network port of a second network device 113b of the machine network 110. A first network device 113a having first network ports (e.g., 1-4 CAN ports) transmits and receives communications from first network ports of the implement. In one example, the implement network 150 includes nozzles 50, lights 60, vision guidance system 1170 having cameras and processors, and autosteer controller 1120 for various embodiments of this present disclosure. The autosteer controller 1120 may also be part of the machine network 110 instead of being located on the implement network 150 or in addition to being located on the implement network 150.

Sensors 152 (e.g., speed sensors, seed sensors for detecting passage of seed, downforce sensors, actuator valves, OEM sensors, flow sensors, etc.), controllers 154 (e.g., drive system for seed meter, GPS receiver), and the processing system 162 control and monitoring operations of the implement.

The OEM sensors may be moisture sensors or flow sensors for a combine, speed sensors for the machine, seed force sensors for a planter, liquid application sensors for a sprayer, or vacuum, lift, lower sensors for an implement. For example, the controllers may include processors in communication with a plurality of seed sensors. The processors are configured to process data (e.g., liquid application data, seed sensor data) and transmit processed data to the processing system 162 or 120. The controllers and sensors may be used for monitoring motors and drives on a planter including a variable rate drive system for changing plant populations. The controllers and sensors may also provide swath control to shut off individual rows or sections of the planter. The sensors and controllers may sense changes in an electric motor that controls each row of a planter individually. These sensors and controllers may sense seed delivery speeds in a seed tube for each row of a planter.

The network interface 160 can be a GPS transceiver, a WLAN transceiver (e.g., WiFi), an infrared transceiver, a Bluetooth transceiver, Ethernet, or other interfaces from communications with other devices and systems including the machine 102. The network interface 160 may be integrated with the implement network 150 or separate from the implement network 150 as illustrated in FIG. 11B.

The processing system 162 communicates bi-directionally with the implement network 150, network interface 160, and I/O ports 166 via communication links 141-143, respectively. The implement communicates with the machine via wired and possibly also wireless bi-directional communications 104. The implement network 150 may communicate directly with the machine network 110 or via the network interfaces 115 and 160. The implement may also by physically coupled to the machine for agricultural operations (e.g., planting, harvesting, spraying, etc.). The memory 105 may be a machine-accessible non-transitory medium on which is stored one or more sets of instructions (e.g., software 106) embodying any one or more of the methodologies or functions described herein. The software 106 may also reside, completely or at least partially, within the memory 105 and/or within the processing system 1200 during execution thereof by the system 100, the memory and the processing system also constituting machine-accessible storage media. The software 1206 may further be transmitted or received over a network via the network interface 115.

In one example, the implement 140, 1240 is an autosteered implement comprising a self-propelled implement with an autosteer controller 1120 for controlling traveling of the self-propelled implement. The controllers 154 include a global positioning system to provide GPS coordinates. The vision guidance system 1170 includes at least one camera and a processor. The global positioning system is in communication with the processor, and the processor is in communication with the autosteer controller. The processor is configured to modify the GPS coordinates to a modified GPS coordinates to maintain a desired travel for the self-propelled implement.

In another example, the machine 102 is an autosteered machine comprising a self-propelled machine with an autosteer controller 1120 for controlling traveling of the self-propelled machine and any implement that is coupled to the machine. The controllers 154 include a global positioning system to provide GPS coordinates. The vision guidance system 1170 includes at least one camera and a processor. The global positioning system is in communication with the processor, and the processor is in communication with the autosteer controller. The processor is configured to modify the GPS coordinates to a modified GPS coordinates to maintain a desired travel for the self-propelled machine.

In another example, a boom actuation system 170 moves a boom arm 22 of the implement between a storage position and a deployed position, and the arm is actuated with the boom actuation system.

In one embodiment, a machine-accessible non-transitory medium (e.g., memory 105) contains executable computer program instructions which when executed by a data processing system cause the system to perform operations or methods of the present disclosure

It will be appreciated that additional components, not shown, may also be part of the system in certain embodiments, and in certain embodiments fewer components than shown in FIG. 11A and FIG. 11B may also be used in a data processing system. It will be appreciated that one or more buses, not shown, may be used to interconnect the various components as is well known in the art.

### Examples

The following are non-limiting examples.

Example 1—A computer implemented method for calibration of a camera comprising capturing, with the camera that is disposed on an implement, a sequence of images while the implement travels across terrain, comparing a first image from an image sensor of the camera at a first time to a second image from the image sensor at a second time, determining matching points corresponding to features in common in the first image and in the second image, and determining at least one of height, pitch, roll, and yaw for the camera based on the first image, the second image, the matching points corresponding to features in common in the first image and in the second image, and a ground speed of the implement while capturing the first image at the first time and the second image at the second time.

Example 2—The computer implemented method of Example 1, further comprises receiving x and y (e.g., lateral and longitudinal) positions of the camera with respect to a centerline of the implement.

Example 3—The computer implemented method of Example 2, further comprises receiving a steering angle from a steering sensor of the implement and receiving the ground speed of the implement while capturing the first image at the first time and the second image at the second time from a speed sensor.

Example 4—The computer implemented method of any preceding Example, further comprises determining a forward distance traveled by the implement between capturing the first image at the first time and second image at the second time.

Example 5—The computer implemented method of any preceding Example, wherein the height, pitch, roll, and yaw for the camera are determined based on the first image and the second image.

Example 6—The computer implemented method of any preceding Example, wherein the features in common in the first image and in the second image include a region of a plant or a weed in the agricultural field.

Example 7—The computer implemented method of any preceding Example, wherein the camera is disposed to look ahead in a direction of travel of the implement or to look downwards.

Example 8—A system comprising an agricultural implement, a camera disposed on the agricultural implement, the camera is configured to capture a sequence of images while the agricultural implement travels through an agricultural field, and a processor that is configured to compare a first image from an image sensor of the camera at a first time to a second image from the image sensor at a second time, determine matching points corresponding to features in common in the first image and in the second image, and determine at least one of height, pitch, roll, and yaw for the camera based on the first image, the second image, the matching points corresponding to features in common in the first image and in the second image, and a ground speed of the agricultural implement while capturing the first image at the first time and the second image at the second time.

Example 9—The system of Example 8, wherein the processor is further configured to receive x and y (e.g., lateral and longitudinal) positions of the camera with respect to a centerline of the agricultural implement.

Example 10—The system of any of preceding Examples 8-9, wherein the processor is further configured to receive a steering angle from a steering sensor of the implement and to receive the ground speed of the implement while capturing the first image at the first time and the second image at the second time from a speed sensor.

Example 11—The system of any of preceding Examples 8-10, wherein the processor is further configured to determine a forward distance traveled by the implement between capturing the first image at the first time and second image at the second time.

Example 12—The system of any of preceding Examples 8-11, wherein the features in common in the first image and in the second image include a region of a plant or a weed in the agricultural field.

Example 13—The system of any of preceding Examples 8-12, wherein the height, pitch, roll, and yaw for the camera are determined based on the first image and the second image, and known machine translation between those frames of the first and second images.

Example 14—The system of any of preceding Examples 8-13, wherein the camera is disposed to look ahead in a direction of travel of the implement or to look downwards.

Example 15-A computer implemented method for aligning a second image sensor with a first image sensor of a camera, comprising using a calculated height, pitch, roll, and yaw for the camera that is disposed on an implement to calculate a real world projection matrix for the first image sensor to allow features, image points, or pixels from an image space to be projected into a real world ground projected coordinates, determining a value for each corner point for the real world ground projected coordinates from the first image sensor, calculating a nominal disparity based on each of the corner points for the real world ground projected coordinates and corner points in image space of the first image sensor; warping a first image from the first image sensor by the nominal disparity for each of those corner points; and determining a registration matrix to align a second raw image from the second image sensor with the disparity warped first image based on intrinsic camera parameters.

Example 16—The computer implemented method of Example 15, wherein the intrinsic camera parameters include a focal length and a pixel spacing of a first lens of the first image sensor.

Example 17—The computer implemented method of any of preceding Examples 15-16, further comprises determining a height of the camera for each frame based on a determined distance from the camera to a feature in an agricultural field.

Example 18, The computer implemented method of Example 17, wherein the feature is a plant or a weed.

Example 19—The computer implemented method of any of preceding Examples 15-18, wherein the height, pitch, roll, and yaw for the camera are determined from a camera calibration process.

Example 20—The computer implemented method of any of preceding claims 15-19, wherein the camera comprises a stereo vision camera.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures but is to be accorded the widest scope consistent with the spirit and scope of the appended claims.

1. A computer implemented method for calibration of a camera comprising:
capturing, with the camera that is disposed on an implement, a sequence of images while the implement travels across terrain;
comparing a first image from an image sensor of the camera at a first time to a second image from the image sensor at a second time;
determining matching points corresponding to features in common in the first image and in the second image; and
determining at least one of height, pitch, roll, and yaw for the camera based on the first image, the second image, the matching points corresponding to features in common in the first image and in the second image, and a ground speed of the implement while capturing the first image at the first time and the second image at the second time.

2. The computer implemented method of claim 1, further comprising:
receiving x and y positions of the camera with respect to a centerline of the implement.

3. The computer implemented method of claim 1, further comprising:
receiving a steering angle from a steering sensor of the implement; and
receiving the ground speed of the implement while capturing the first image at the first time and the second image at the second time from a speed sensor.

4. The computer implemented method of claim 1, further comprising:
determining a forward distance traveled by the implement between capturing the first image at the first time and second image at the second time.

5. The computer implemented method of claim 1, wherein the height, pitch, roll, and yaw for the camera are determined based on the first image and the second image.

6. The computer implemented method of claim 1, wherein the features in common in the first image and in the second image include a region of a plant or a weed in the agricultural field.

7. The computer implemented method of claim 1, wherein the camera is disposed to look ahead in a direction of travel of the implement or to look downwards.

8. A system comprising:
an agricultural implement;
a camera disposed on the agricultural implement, the camera is configured to capture a sequence of images while the agricultural implement travels through an agricultural field; and
a processor that is configured to compare a first image from an image sensor of the camera at a first time to a second image from the image sensor at a second time, determine matching points corresponding to features in common in the first image and in the second image, and determine at least one of height, pitch, roll, and yaw for the camera based on the first image, the second image, the matching points corresponding to features in common in the first image and in the second image, and a ground speed of the agricultural implement while capturing the first image at the first time and the second image at the second time.

9. The system of claim 8, wherein the processor is further configured to receive x and y positions of the camera with respect to a centerline of the agricultural implement.

10. The system of claim 8, wherein the processor is further configured to receive a steering angle from a steering sensor of the agricultural implement and to receive the ground speed of the agricultural implement while capturing the first image at the first time and the second image at the second time from a speed sensor.

11. The system of claim 8, wherein the processor is further configured to determine a forward distance traveled by the agricultural implement between capturing the first image at the first time and second image at the second time.

12. The system of claim 8, wherein the features in common in the first image and in the second image include a region of a plant or a weed in the agricultural field.

13. The system of claim 8, wherein the height, pitch, roll, and yaw for the camera are determined based on the first image and the second image, and known machine translation between those frames.

14. The system of claim 8, wherein the camera is disposed to look ahead in a direction of travel of the implement or to look downwards.

15. A computer implemented method for aligning a second image sensor with a first image sensor of a camera, comprising:
using a calculated height, pitch, roll, and yaw based on captured images in an agricultural field for the camera that is disposed on an implement to calculate a real world projection matrix for the first image sensor to allow features, image points, or pixels from an image space to be projected into real world ground projected coordinates;
determining a value for each corner point for the real world ground projected coordinates from the first image sensor;
calculating a nominal disparity based on each of the corner points for the real world ground projected coordinates and corner points in image space of the first image sensor;
warping a first image from the first image sensor by the nominal disparity for each of those corner points; and
determining a registration matrix to align a second raw image from the second image sensor with the disparity warped first image.

16. The computer implemented method of claim 15, wherein the intrinsic camera parameters include a focal length and a pixel spacing of a first lens of the first image sensor.

17. The computer implemented method of claim 15, further comprises:
determining a height of the camera for each frame based on a determined distance from the camera to a feature in an agricultural field.

18. The computer implemented method of claim 17, wherein the feature is a plant or a weed.

19. The computer implemented method of claim 15, wherein the height, pitch, roll, and yaw for the camera are determined from a camera calibration process.

20. The computer implemented method of claim 15, wherein the camera comprises a stereo vision camera.
